(19) United States
(12) Patent Application Publication
(10) Pub. No.: US 2007/0006145 A1
(43) Pub. Date: Jan. 4, 2007

(54) Iterative operator in a graphical programming language

(76) Inventors: Russell Keith Hill, Fort Collins, CO (US); Susan G. Wolber, Ft Collins, CO (US)

Correspondence Address: AGILENT TECHNOLOGIES INC., INTELLECTUAL PROPERTY ADMINISTRATION, M/S DU404, P.O. BOX 7599, LOVELAND, CO, 80537-0599, US

(21) Appl. No.: 11/121,600

(22) Filed: May 4, 2005

(51) Int. Cl. G06F 9/44

(52) U.S. Cl. 717/114; 717/113

(57) ABSTRACT

A system and method for iterating has a processor executing a graphical programming language that includes an operator for iterating through a data structure where the data structure is a plurality of elements having arbitrary rank and dimension sizes.

### BACKGROUND

Graphical programming languages provide an intuitive user interface for development of software applications. Advantageously, graphical programming languages are not as difficult to learn as a textual language, are not as susceptible to syntax errors, and permit a program developer to focus on the actual task to perform rather than the methods to perform them. Graphical programming languages provide organizational and visual tools to permit faster program development with fewer errors than textual languages. One of the benefits of graphical programming languages is the general applicability of its constructs. Specifically, a program developer may employ similar graphical objects to perform similar functions making program development easier than development of a similarly functional program in one of the textual languages. For purposes of the present description, the program developer is a person who creates a program and the user is a person who executes the program created. The program developer and user may in fact be the same human being, but each have a different name in this description for the purpose of overall clarity.

An example of a data manipulation function that is useful to a program developer is iterative processing of a data structure that includes a plurality of elements. When processing a data structure, it is desirable to access each element in the data structure and perform some desired operation on each element. In a textual language, iterative processing of a data structure may be performed with a “for loop” where an index into the data structure is incremented through all of the elements. This iterative processing is trivial to one of ordinary skill in the art if the data structure rank and dimension sizes are known during program development, such as for a single dimensional data array. A multidimensional array is similarly processed, but in two or more nested for loops where each loop increments an index over the maximum range, each index representing one of the dimensions of the array. Nested loops are known in textual languages and are implemented in graphical programming languages provided the rank and dimension sizes are known as the program is in development. Even if the rank and dimension sizes are known, if a program developer changes their mind concerning the data structure during program development, they must also make a change to the nature and possibly structure of the iterative operations to maintain consistency with the data structure. Iterative processing of a data structure where the rank and dimension sizes are not known prior to program execution is a non-trivial programming challenge. Some textual languages include the high level function of a for each operator. Iterative processing of a data structure of arbitrary rank and dimension size, however, is not available in a graphical programming language. An ability to handle arbitrary rank and dimension sizes of arrays and other collections permits creation of more generally applicable programs for multiple kinds of data structures. An alternative is to create an object for each of the different rank and dimension sizes for alternative anticipated data structures that are conditionally executed once the data structure rank and dimensions are known. While this alternative may be an option under certain circumstances, as can be readily appreciated, such an alternative significantly increases the length and complexity of a program without significantly increasing the general utility.

There is a need, therefore, for a system and method for iterating over a data structure having arbitrary rank and dimension sizes.

### BRIEF DESCRIPTION OF THE DRAWINGS

An understanding of the present teachings can be gained from the following detailed description, taken in conjunction with the accompanying drawings of which:

FIG. 1 is a block diagram of a system executing a graphical programming language.

FIG. 2 is an illustration of a first embodiment of an iterative operator according to the present teachings as seen by a program developer.

FIG. 3 is an illustration of the first embodiment of the iterative operator in an example context.

FIG. 4 is a second embodiment of an iterative operator according to the present teachings as seen by a program developer.

FIG. 5 is an illustration of the second embodiment of the iterative operator in an example context.

FIG. 6 is a flow chart of a development process that uses an embodiment of the iterative operator according to the present teachings.

FIGS. 7 through 10 illustrate a flow chart of an embodiment of the process initiated by the iterative operator.

### DETAILED DESCRIPTION

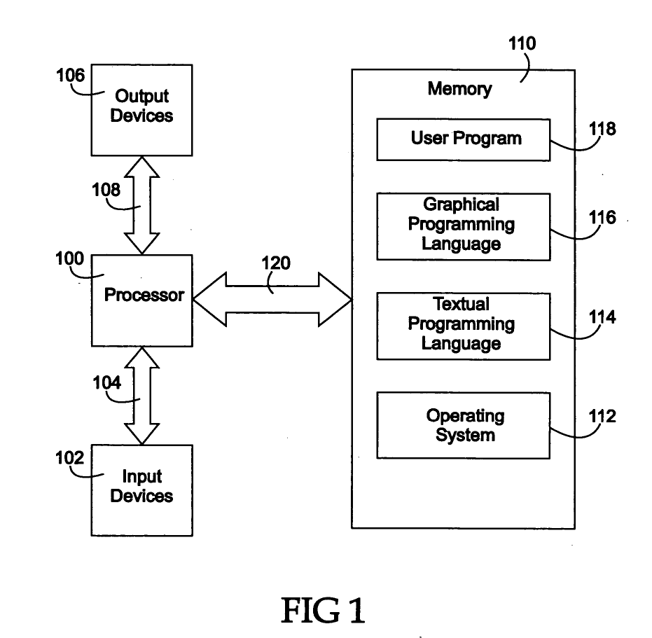

With specific reference to FIG. 1 of the drawings there is shown a block diagram of a processing system executing a graphical programming language 116 in which a processor 100 communicates with one or more input devices 102. Example input devices 102 include without limitation a keyboard, mouse, measurement instrument and all currently known or later developed input devices that communicate with the processor 100 over a suitable input communications link 104. The processor 100 also communicates with one or more output devices 106. Example output devices 106 include without limitation a monitor, printer, electronic instrument and all currently known or later developed output devices that communicate with the processor 100 over a suitable output communications link 108. The processor 100 has access to memory 110. The memory stores an operating system 112, which is executed by the processor 100. In a specific embodiment, the operating system 112 is a Microsoft Windows operating system including the COM and .NET components. The operating system 112 supports a textual programming language 114 that is used to support a graphical programming language 116. In a specific embodiment, the graphical programming language is the VEE software from Agilent Technologies, Inc., which is written in a combination of the C, Objective C, C++ and C# programming languages 114. A program developer uses the graphical programming language 116 to generate and then execute a program 118. The graphical programming language 116 offers many different objects that provide functions. Some of those functions include data acquisition, analysis and display functions. In a specific embodiment, the user accesses a menu using one or more input devices 102 and selects one of the many different available objects. Selection of one of the objects places a visual indication of the selected object on the output device 106, which is typically a monitor. Example objects in VEE include without limitation operator interface data input objects such as a slider or data entry control, data analysis objects such as an fast Fourier transfer function, fft( ), or statistical function, data display objects such as an xy chart or alphanumeric display, and flow control objects such as an if . . . then . . . else or until . . . break object. An object according to the present teachings is referred to as a “for each” object. The “for each” object is an iterative operator. Specifically, the iterative operator accepts a data structure of arbitrary type and with arbitrary rank and dimension sizes. The data structure represents a plurality of elements and the iterative operator iterates over each element within the data structure. The iterative operator according to the present teaching may be used for any available data structure and is independent of data structure type, format, and size. In a specific implementation, the data structure can be an array, a COM collection or a .NET collection. Each of these data structures are implemented differently within the operating system and have different application programming interfaces (“APIs”). The most common type of data found in a data structure includes without limitation strings, 32-bit integers, 64-bit integers, 32-bit real numbers, and 64-bit real number elements or a combination of elements. There are other less common types including without limitation, polar complex numbers and coordinate numbers.

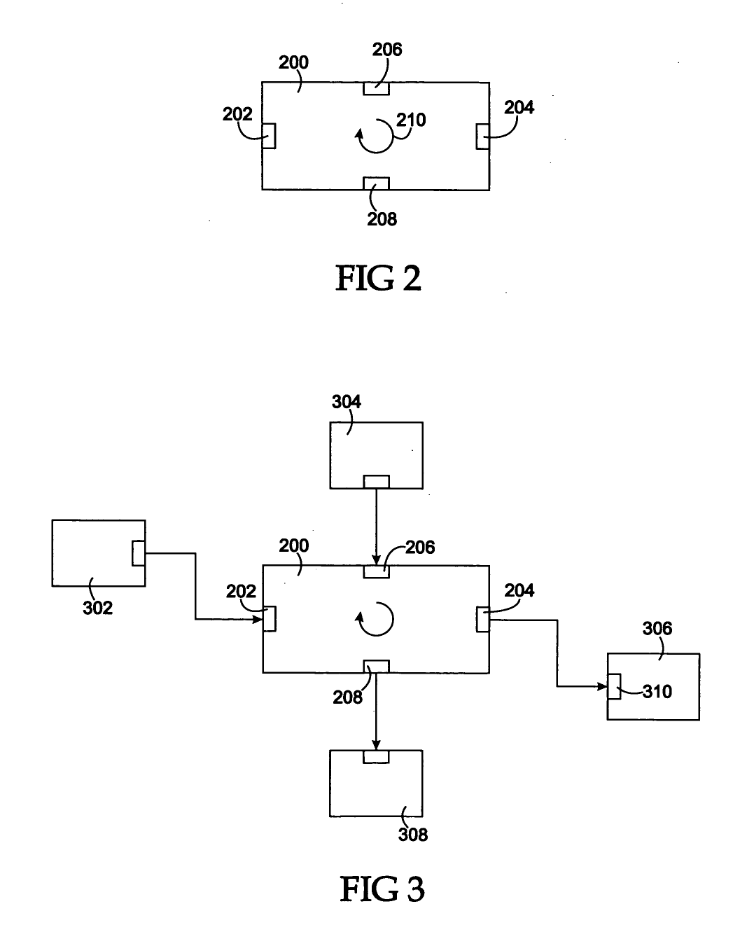

With specific reference to FIG. 2 of the drawings, there is shown a first specific embodiment of the graphical object for the iterative operator 200. A coiled arrow graphic 210 is shown in the center of the iterative operator graphical object to provide an indication of its function. The iterative operator 200 shown in FIG. 2 has an input pin 202, an output pin 204, a hold-off pin 206 and a finish pin 208. The input pin 202 provides a graphical access point to the data structure that is to be iterated. Another graphical programming object is connected to the input pin 202 to provide the source of the data structure. The output pin 204 provides a graphical access point for each element in the data structure. One or more graphical programming objects may be connected to the output pin 204 to receive and operate further on each element as programmed by the program developer. The collection of graphical programming objects that are connected to the output pin 204 may be connected in parallel or cascaded and are referred to as a downstream process. From an iterative operator sequencing perspective, the downstream process is completed for each element in the data structure before the iteration loop for the next element. The hold-off pin 206 provides an input signal to the iterative object to initiate the iterative process. If the hold-off pin 206 is connected to another graphical programming object, the iterative operation is not initiated until the hold-off pin 206 presents an affirmative indication to start the iterative operation. If the hold-off pin 206 is not connected to another graphical programming object, the iterative operation begins when data is presented to the input pin 202. The finish pin 208 provides an indication of completion by the iterative operation to one or more graphical programming objects attached to it.

With specific reference to FIG. 3 of the drawings, there is shown a simplified illustration of the first embodiment of the iterative operator 200 in context of a user developed program 118. The iterative operator 200 may be placed in context to accept a data structure (not shown) from an upstream network 302 via its input pin 202. The upstream network 302 may be one or more interconnected graphical programming objects that perform some function. An output of the upstream network 302 provides the data structure for the iterative operator 200 and is connected to the input pin 202. The data structure provided by the upstream network 302 may be one of any type and rank and dimension size that is supported by the graphical programming language 116 and the iterative operator 200 and the interface to it does not change. In a specific implementation, the iterative operation 200 does not support all data structures because it does not make sense to iterate over them. In that case, the iterative operator generates an error if one of the unsupported data structures is provided as an input. The data structure is provided to the iterative operator 200 as a single reference. The iterative operator 200 may also be connected to a trigger network 304. The trigger network 304 may be one or more interconnected graphical programming objects. If a trigger network 304 is connected to the hold-off pin 206, the iterative operator 200 does not initiate the iterative operation unless and until the hold-off pin 206 is stimulated with a signal to proceed. The hold-off pin 206 permits delaying initiation of the iterative operation until another operation is complete. The hold-off pin 206, therefore, provides synchronization and timing for the iterative operation. If nothing is connected to the hold-off pin 206, the iterative operation initiates immediately when the data structure is presented to it at the input pin 202. Upon initiation, the iterative operator 200 identifies the first element in the data structure and places its value at the output pin 204. The output pin 204 pipes the first element to a downstream network 306 that may be one or more interconnected graphical programming objects. The process represented by the downstream network 306 connected to the output pin 204 completes before the iterative operator 200 retrieves a next element in the data structure. The downstream network 306 processes each element in the data structure one by one as provided by the iterative operator 200. When all elements in the data structure are processed, the iterative operation is complete. Upon completion, the iterative operator 200 provides an indication of the completion at the finish pin 208. The finish pin 208 is connected to a next, network 308 of one or more interconnected graphical programming objects. The process represented by the next network 308 does not initiate until the iterative operator 200 indicates that the iterative and downstream network 306 process is finished. Advantageously, the user program 118 does not require a different program structure that depends upon the type of data in the data structure and the rank and dimension sizes of the data structure.

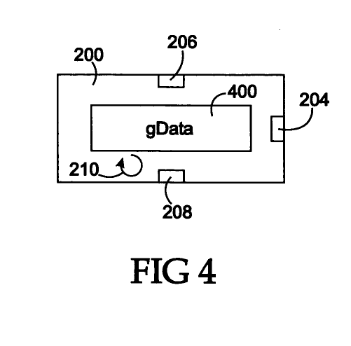

With specific reference to FIG. 4 of the drawings, there is shown a second embodiment of the iterative operator 200 according to the present teachings in which the input pin 202 is not present. Access to the data structure is made via an expression field 400 in the iterative operator 200. A name of the data structure is loaded into the expression field 400. When the hold-off pin 206 receives a signal, the iterative operator initiates its operation by accessing the referenced data structure and retrieving a first element in the referenced data structure. Each element of the data structure is retrieved and presented in turn at the output pin 204. The process of the downstream network 204 completes before the downstream network 204 accepts the next element presented to it by the iterative operator 200. In another use for the second embodiment of the iterative operator 200, a mathematical expression is used in the expression field 400. The mathematical expression may be any of the known operators including without limitation addition, subtraction, multiplication, sine/cosine/tangent, exponential and a combination of these. Alternatively, two or more data structures may be referenced in the expression field 400 for operations against each other. For example, two multi-dimensional arrays may be multiplied or divided before the each element of the array resulting from the expression is presented at the output pin 204. The expression is solved for each element in the data structure(s) as it is retrieved and the solution to the expression is presented element by element to the output pin 204. When the iterative operation and the process represented by the downstream network 306 is complete for each element in the data structure(s), the iterative operator 200 provides an indication of completion at the finish pin 208.

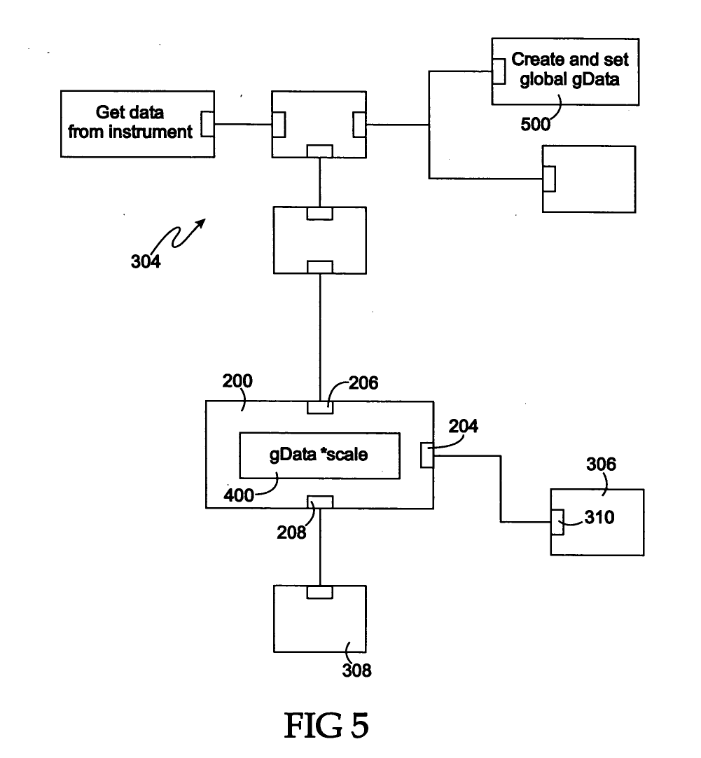

With specific reference to FIG. 5 of the drawings, there is shown a simplified illustration of the second embodiment of the iterative operator 200 in context of the user developed program 118. The trigger network 304 is shown as an interconnected grouping of various graphical programming objects to better illustrate the point that the data structure referenced in the expression field 400 is created elsewhere, see 500, in the user program 118 as a global variable. One or more operations are performed to populate and perhaps operate on the data structure. When operation on the data structure is complete, the trigger network 304 indicates its completion to the iterative operator 200 via the hold-off pin 206. As described with reference to FIG. 4, the iterative operator initiates the iterative process and retrieves and executes the downstream process 306 element by element. Advantageously, the user program 118 does not require external a priori knowledge of the type and rank and dimension size of the data structure.

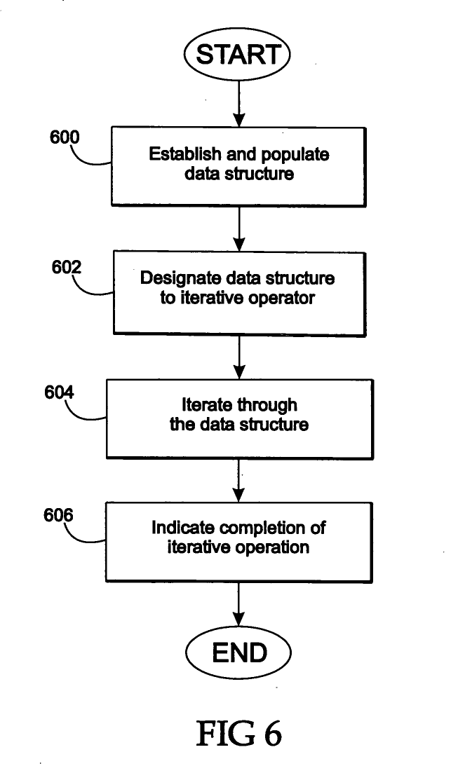

With specific reference to FIG. 6 of the drawings, there is shown a flow chart of a process for use of the iterative operator 200 in which a user establishes and populates 600 at least one data structure. The population step may be performed by calculation or by retrieving external data from one or more input devices 102. At some point in the user program, the data structure is designated 602 to the iterative operator. The designation occurs by providing the data structure at the input pin 202 of the iterative operator 200, as shown in FIG. 2 and 3, or referencing the data structure via the expression field 400 of the iterative operator 200, as shown in FIGS. 4 and 5. The iterative operator 200 then iterates 604 element by element through the data structure and presents each element at the output pin 204. When the iterative operation completes, the iterative operator 200 indicates 606 as such at the finish pin 208.

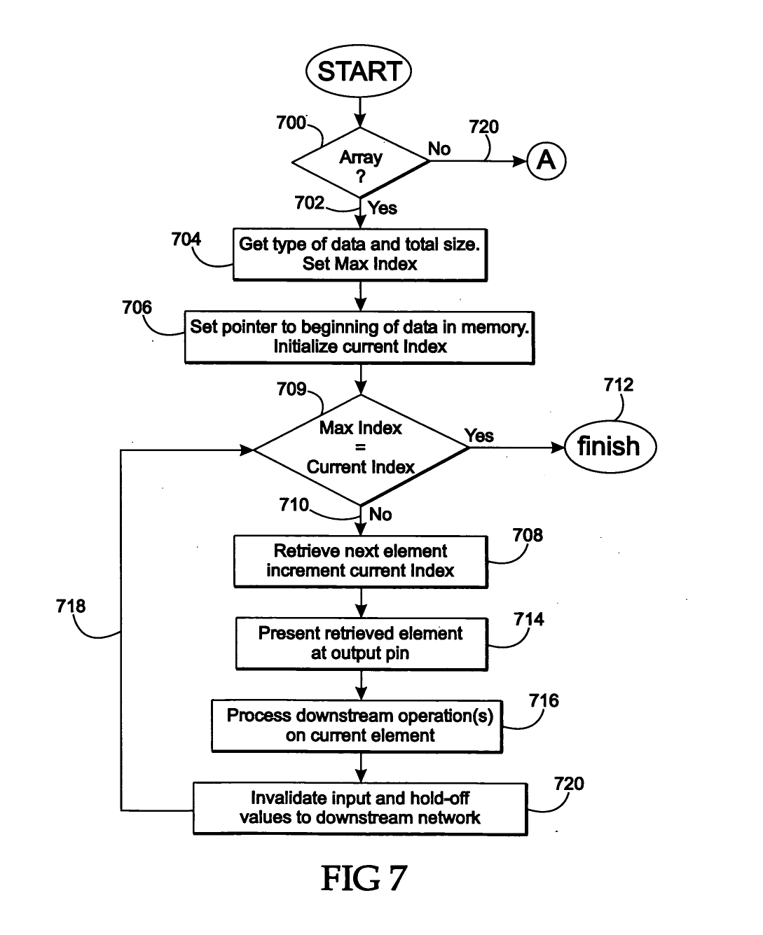

With specific reference to FIGS. 7 through 10, there is shown a flow chart of the iterative process performed by the iterative operator 200. As already disclosed, the iterative operator 200 is able to iterate over an array of any type and rank and dimension size, a COM object that implements IEnum VARIANT (i.e. a COM collection) and a .NET object that has either the GetEnumerator method or implements IEnumerable (i.e. a Net collection). Upon initiation, the iterative process first determines 700 if the data structure is an array. If it is 702, it makes a request to obtain 704 the type of data contained in the array as well as the total size of the array. It sets 704 a MaxIndex value to the total size of the array. In a specific embodiment of the graphical programming language 116, an array type data structure is stored in contiguous memory. Multi-dimensional arrays are also stored in contiguous memory in row major order. Accordingly, by knowing the type and size of the array, the process can set 706 a pointer to a beginning of the portion of contiguous memory that stores the array. The type of data indicates how many bits are retrieved per element. The total size of the array indicates how many iterations are made to retrieve all elements in the data structure. When the pointer is set, the process compares 709 the maxlndex value to a currentIndex value. The currentIndex value is the number of iterations already processed. If the iterative operator 200 has not yet reached the end of the array, the process retrieves 708 the next element in the array and increments the currentIndex. The retrieved element is presented 714 at the output pin 204 of the iterative operator 200. When the retrieved element is made available to the output pin 204, it sets a status bit that is monitored and recognized by the downstream network 306. When the status bit is set to a true value, the process represented by the downstream network 306 is initiates and completes 716. The input and holdoff values of the downstream network 306 are invalidated 720 before the iterative process loops 718 to determine is there is another element in the data structure 708. In general, the process represented by an object is initiated when valid data is presented at the object's input 202 or hold-off 206 pins. The process of the downstream network 306 is initiated when valid data is available at an input pin 310 of the first object in the downstream network 306. Prior to execution, the graphical programming language examines the objects in the developed program and the lines connecting the objects to determine an order of execution. As a rule, data flows left to right and top to bottom as established in the developed program. The graphical programming language 116 directs the objects that make up the downstream network 306 to execute. The downstream network 306 processes each retrieved data element in the order established by the program. When the process represented by the downstream network 306 completes execution on the retrieved element, program control returns to the iterative element 200. The iterative object 200 then invalidates 720 all the data and hold-off inputs of the objects in the downstream network 306 in preparation for the iterative loop 718: If at the compare step 709, MaxIndex is found to equal the Current Index value, the iterative process 200 finishes 712. The finish step 712 includes setting the finish pin 208 with valid data which is recognized as valid data at an input pin (for example 310) of the next object subject to execution.

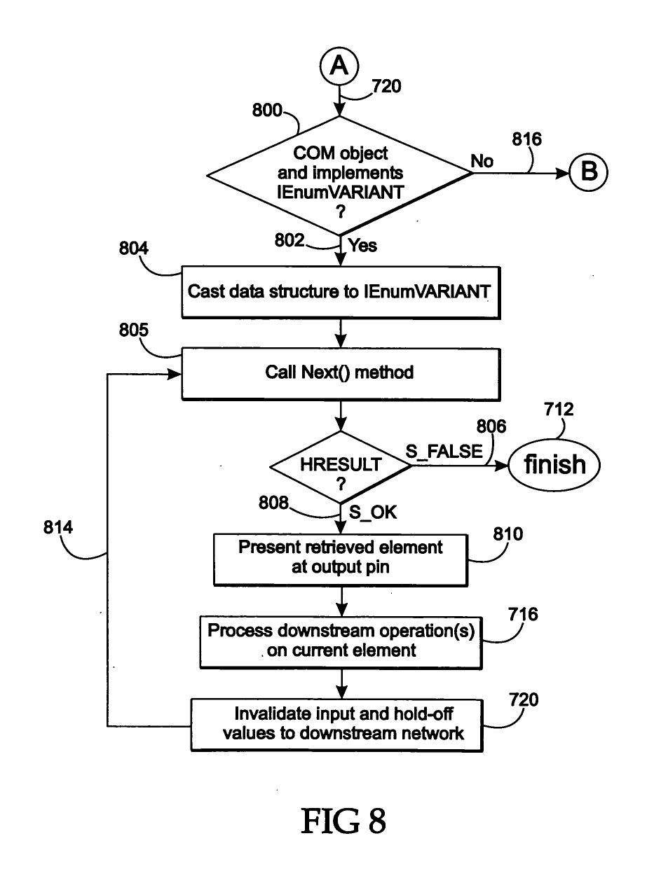

With specific reference to FIG. 8 of the drawings, there is shown a portion of the iterative process if the data structure is not 720 an array. If not an array, the iterative operator 200 determines 800 if the data structure is a COM collection. In the specific embodiment illustrated, the data structure is a COM collection if it is a COM object and implements the IEnum VARIANT interface. The IEnum VARIANT interface is an application programming interface that is defined and supported by the Microsoft® COM library. If so 802, the iterative operator 200 casts 804 the data structure to Interface (type) IEnum VARIANT. The iterative operator then calls 805 the Next( ) method to retrieve the next element in the data structure. The Next( ) method returns a parameter HRESULT. If HRESULT is returned as S_FALSE 806, it signals that there are no more elements to retrieve in the data structure and the iterative operator finishes 712. If HRESULT is returned as S_OK 808, the retrieved element is presented 810 to the output pin 204. The process represented by the downstream network 306 is initiated and completed 812, 720 before the iterative process loops 814 to retrieve the next element in the data structure by calling 805 the Next( ) method.

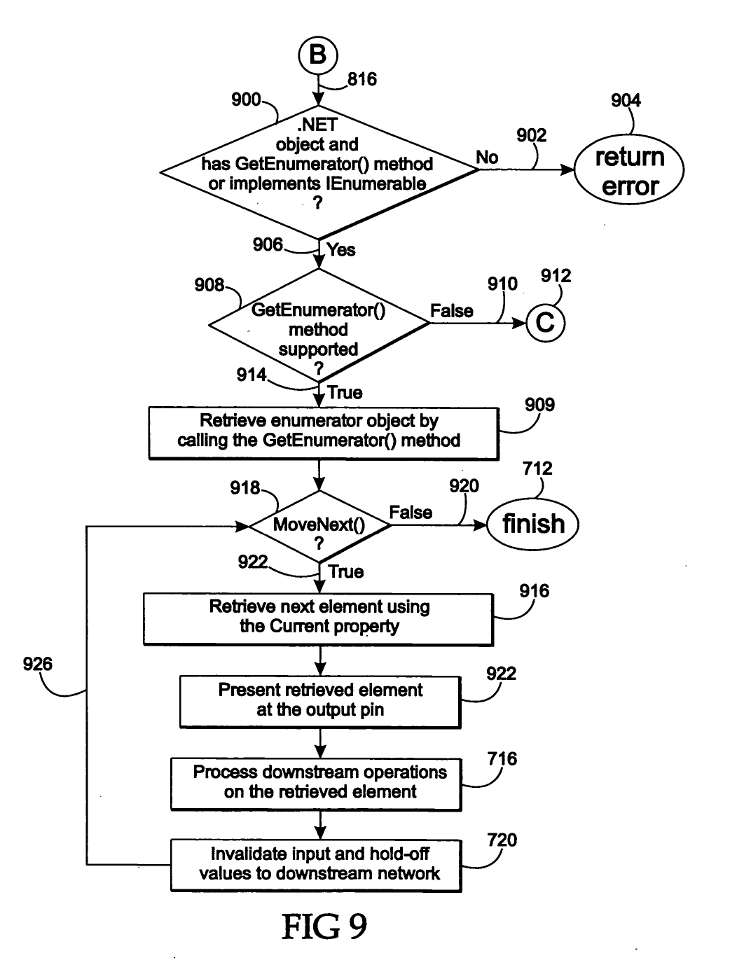

With specific reference to FIG. 9 of the drawings, there is shown a portion of the iterative operator process if the data structure is not an array or a COM collection that implements the IEnum VARIANT function 816 in which the iterative process determines 900 if the data structure is a .NET object and has either the GetEnumerator method or implements the IEnumerable interface. If so, the data structure is referred to as a .NET collection. A .NET collection is a data structure supported by the Microsoft® .NET Framework. The GetEnumerator( ) method and IEnumerable interface are used in a specific embodiment of the iterative operator 200 and are defined and supported by the Microsoft® .NET Framework. If the data structure is not a .NET collection that has either the GetEnumerator( ) method or implements the IEnumerable interface 902, the iterative operator 200 returns an error 904 and the iterative operator 200 does not perform the iterative operations. If the data structure is a .NET object that has either the GetEnumerator( ) method or implements the IEnumerable interface 906, the iterative operator 200 determines 908 if the GetEnumerator( ) method is correctly and fully supported by asking the return value of the GetEnumerator( ) method if that object returned also supports both a MoveNext( ) method and a Current property. If it is not supported 910, the iterative operator 200 continues to another part of the process 912. If the GetEnumerator( ) method is fully supported 914, the GetEnumerator( ) method is called 909. The iterative operator 200 then calls the MoveNext( ) method 918 to enumerate over the .Net collection data structure. The MoveNext( ) method returns a boolean value of false if it encounters an end of the data structure and a true if it does not. The iterative operator 200 queries the returned value and if the value is false 920, the process finishes 712. If the returned value is true 922, the process retrieves 916 the next element of the data structure using the GetEnumerator( )'s IEnumerable.Current property. The retrieved element is then presented 922 at the output pin 204. As each element is presented at the output pin 204, the process represented by the downstream network 306 is initiated and completed 716, 720 for each element before looping 926 to retrieve 918, 916 the next element in the data structure.

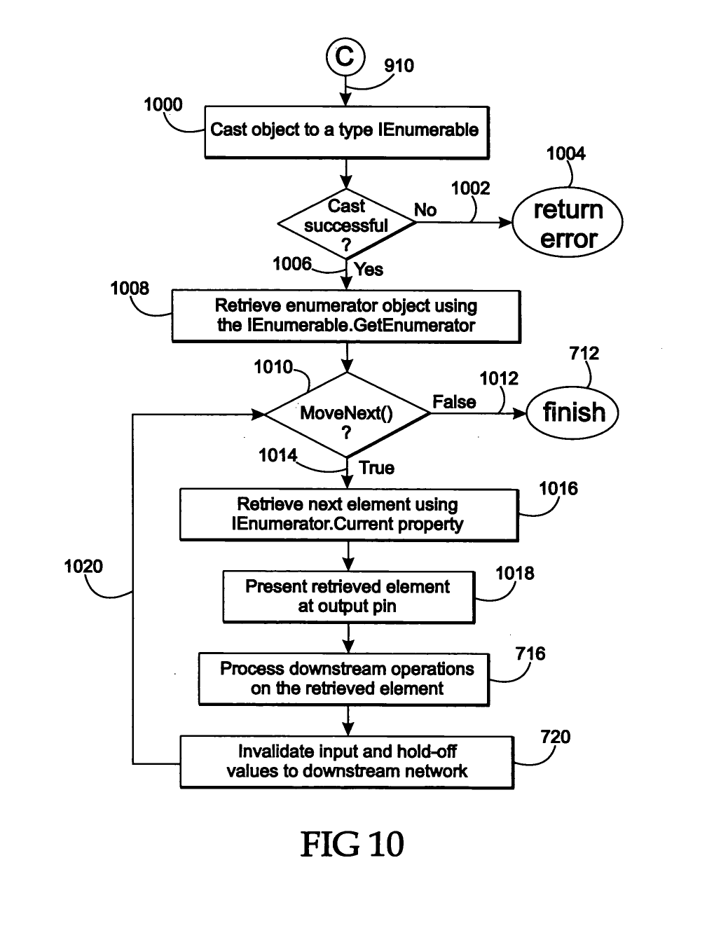

With specific reference to FIG. 10 of the drawings, there is shown a further portion of the iterative operator process. If the data structure is not an array, COM collection, or .NET object that does not support the IEnumerable GetEnumerator( ) method 910, it is assumed that the IEnumerable interface is supported because of the prior verification done in 900. Accordingly, the iterative process casts 1000 the data structure to interface type IEnumerable. If the cast is not successful 1002, the portion of the .NET framework used by the iterative operator 200 is not fully supported and the iterative operator 200 returns an error 1004 and does not perform the iterative process. If the cast is successful 1006, the iterative operator uses 1008 the IEnumerable's GetEnumerator( ) method's returned object which implements a MoveNext( ) method 1010 and a Current property. The MoveNext( ) method 1010 returns a boolean value of false if it encounters an end of the data structure and a true if it does not. If no more elements remain for retrieval 1012, the iterative operator finishes 712. If elements remain in the data structure 1014, the next element is retrieved 1016 using the IEnumerable.Current property. The retrieved element is presented 1018 at the output pin 204. As each element is presented at the output pin 204, the process represented by the downstream network 306 is initiated and completed 716, 720 for each element before looping 1020 to retrieve 1016 the next element in the data structure. Advantageously, the iterative operator 200 is able to operate on the plurality of data structures that are supported without requiring the program developer to consider and accommodate the differences when creating the developed program. Support of arbitrary data type and rank and dimension sizes by the same iterative object renders program development and modification using a graphical programming language easier and less prone to development errors requiring debug.

The present teachings are disclosed by way of illustration for one or more embodiments. Specific embodiments, therefore, are illustrative rather than limitative. Other embodiments not specifically disclosed are contemplated by the present teachings and will occur to one of ordinary skill in the art without departing from the scope of the appended claims.

1. A system comprising:
a processor executing a graphical programming language, the language providing an iterative operator for iterating through at least one data structure comprising a plurality of elements, the data structure having arbitrary rank and dimension sizes.

2. A system as recited in claim 1 wherein each data structure is chosen from the group consisting of an array, a COM collection, and a .NET collection.

3. A system as recited in claim 2 wherein the iterative operator is the same for all of the data structures in the group.

4. A system as recited in claim 2 wherein the data structure is a multidimensional array.

5. A system as recited in claim 1 wherein said iterative operator comprises an input pin that accepts the data structure and an output pin that provides each element in a series output.

6. A system as recited in claim 1 wherein said iterative operator comprises a hold off pin and accepts a reference to a data structure.

7. A system as recited in claim 1 and further comprising visual indication of the iterative operator data processing sequence.

8. A system as recited in claim 1 wherein the iterative operator further comprises an output pin and a finish pin.

9. A system as recited in claim 1 wherein operators connected to the output pin are completed before a signal is presented to the finish pin.

10. A computer implemented method for iterating through a data structure in a graphical programming language comprising the steps of:
establishing the data structure having arbitrary rank and dimension sizes and comprising a plurality of elements,
providing the data structure as an input to an iterative operator in a graphical programming language,
iterating through the data structure, and
providing each element of the data structure as an output series from the iterative operator.

11. A method as recited in claim 10 wherein each data structure is chosen from the group consisting of an array, a COM collection, and a .NET collection.

12. A method as recited in claim 11 wherein the data structure is a multidimensional array.

13. A method as recited in claim 10 wherein the iterative operator further comprises an input pin that accepts the data structure and an output pin that provides each element in a series output.

14. A method as recited in claim 10 wherein said iterative operator comprises a hold off pin and accepts a reference to the data structure.

15. A method as recited in claim 10 and further comprising the step of visually indicating a data flow sequence for the iterative operator.

16. A method as recited in claim 10 wherein the iterative operator further comprises an output pin and a finish pin.

17. A method as recited in claim 10 wherein operators connected to the output pin are completed before a signal is presented to the finish pin.

18. A system for iterating through a data structure comprising:
a processor programmed with instructions to provide a graphical programming language for program development, the graphical programming language including an iterative operator to perform iterative operations on the data structure, each data structure comprising an arbitrary plurality of elements, the iterative operator comprising a designator for referencing the data structure to the iterative operator, and an output pin providing each element of the data structure as an output from the iterative operator.

19. A system as recited in claim 18 wherein the data structure is any one chosen from the group consisting of an array, a COM collection, and a .NET collection.

20. A system as recited in claim 19 wherein the data structure is a multidimensional array.

21. A system as recited in claim 18 wherein the designator comprises an input pin that accepts the data structure for processing by the iterative operator.

22. A system as recited in claim 18 wherein the iterative operator comprises a hold off pin and the designator comprises a field that provides reference to a data structure.

23. A system as recited in claim 18 and further comprising visual indication of a data processing sequence of the iterative operator.

24. A system as recited in claim 18 wherein the iterative operator further comprises a finish pin.

25. A system as recited in claim 24 wherein operators connected to the output pin are completed before a signal is presented to the finish pin.
